(19) United States
(12) Patent Application Publication
(10) Pub. No.: US 2022/0006319 A1
(43) Pub. Date: Jan. 6, 2022

(54) VEHICLE WITH TOILET AND CONTROL METHOD THEREFOR

(71) Applicant: TOYOTA JIDOSHA KABUSHIKI KAISHA, Toyota-shi (JP)

(72) Inventors: Mitsuharu ARAHAMA, Miyoshi-shi (JP); Masashi YOSHIDA, Toyota-shi (JP); Misaki ITANO, Toyota-shi (JP)

(21) Appl. No.: 17/325,481

(22) Filed: May 20, 2021

(30) Foreign Application Priority Data
Jul. 3, 2020 (JP) 2020-115605

(51) Int. Cl. H02J 9/06; H02J 7/00; H02J 7/35; B60R 15/04; B60R 16/033

(52) U.S. Cl. CPC H02J 9/06; H02J 7/0063; B60R 16/033; B60R 15/04; H02J 7/35

(57) ABSTRACT

A vehicle with a toilet room, includes a first electronic apparatus installed in the vehicle, the first electronic apparatus being configured to operate the toilet room, a first electric system connected to the first electronic apparatus and supplying electric power to the first electronic apparatus, a second electronic apparatus different from the first electronic apparatus installed in the vehicle, a second electric system connected to the second electronic apparatus and supplying electric power to the second electronic apparatus, and control means for performing control for switching between a first state and a second state, the first state being a state in which the control means controls the first electric system and supplies electric power only to the first electronic apparatus, and the second state being a state in which the control means controls the first and second electric systems and supplies electric power to the first and second electronic apparatuses.

### CROSS REFERENCE TO RELATED APPLICATIONS

This application is based upon and claims the benefit of priority from Japanese patent application No. 2020-115605, filed on Jul. 3, 2020, the disclosure of which is incorporated herein in its entirety by reference.

### BACKGROUND

The present disclosure relates to a vehicle with a toilet, i.e., a vehicle equipped with a toilet room.

A vehicle with a toilet, i.e., a truck with a toilet room installed on its bed has been known (e.g., see Japanese Unexamined Patent Application Publication No. 2002-240633).

### SUMMARY

For example, when each of various electronic apparatuses installed in a vehicle is operated, a large amount of electric power is consumed, so that there is a risk that sufficient electric power for operating a toilet installed in the vehicle may not be secured.

The present disclosure has been made to solve the above-described problem, and an object thereof is to save electric power in a vehicle, and thereby to provide a vehicle with a toilet capable of securing sufficient electric power for operating the toilet and to provide a method for controlling such a vehicle with a toilet.

To achieve the above-described object, a first exemplary aspect is a vehicle with a toilet including a toilet room, the vehicle with the toilet further including:

a first electronic apparatus installed in the vehicle, the first electronic apparatus being configured to operate the toilet room;

a first electric system connected to the first electronic apparatus, the first electric system being configured to supply electric power to the first electronic apparatus;

a second electronic apparatus different from the first electronic apparatus installed in the vehicle;

a second electric system connected to the second electronic apparatus, the second electric system being configured to supply electric power to the second electronic apparatus; and

control means for performing control for switching between a first state and a second state, the first state being a state in which the control means controls the first electric system and supplies electric power only to the first electronic apparatus, and the second state being a state in which the control means controls the first and second electric systems and supplies electric power to the first and second electronic apparatuses.

In this aspect, the first and second electric systems may include a storage battery configured to supply electric power to the first and second electronic apparatuses.

In this aspect, the first electric system may include a renewable energy-type electric generator configured to generate renewable energy and supply the generated renewable energy to the first electronic apparatus.

In this aspect, when the control means determines that an amount of electricity stored in the storage battery is equal to or smaller than a predetermined amount, or the storage battery has failed, the control means may control the first electric system and switch its state to a first state in which electric power is supplied from the renewable energy-type electric generator to the first electronic apparatus.

In this aspect, the first electronic apparatus may include at least an ostomate-sink drain pump through which water is drained from an ostomate-sink for an ostomate, a toilet drain pump through which water is drained from the toilet, and a water-supply pump through which water is supplied to the toilet.

To achieve the above-described object, another exemplary aspect is a method for controlling a vehicle with a toilet, the vehicle with the toilet further including:

a first electronic apparatus installed in the vehicle, the first electronic apparatus being configured to operate a toilet room;

a first electric system connected to the first electronic apparatus, the first electric system being configured to supply electric power to the first electronic apparatus;

a second electronic apparatus different from the first electronic apparatus installed in the vehicle; and

a second electric system connected to the second electronic apparatus, the second electric system being configured to supply electric power to the second electronic apparatus, in which

the method includes performing control for switching between a first state and a second state, the first state being a state in which the control means controls the first electric system and supplies electric power only to the first electronic apparatus, and the second state being a state in which the control means controls the first and second electric systems and supplies electric power to the first and second electronic apparatuses.

According to the present disclosure, a main object thereof is to save electric power in a vehicle, and thereby to provide a vehicle with a toilet capable of securing sufficient electric power for operating the toilet and to provide a method for controlling such a vehicle with a toilet.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a plan view of a vehicle with a toilet according to a first embodiment;

FIG. 2 is a block diagram showing a schematic system configuration of the vehicle with the toilet according to the first embodiment;

FIG. 3 is a detailed diagram of first and second electric systems and first and second electronic apparatuses;

FIG. 4 is a block diagram showing a system configuration of a vehicle with a toilet according to a second embodiment; and

FIG. 5 is a flowchart showing a process flow for controlling the vehicle with the toilet according to the second embodiment.

### DESCRIPTION OF EMBODIMENTS

### First Embodiment

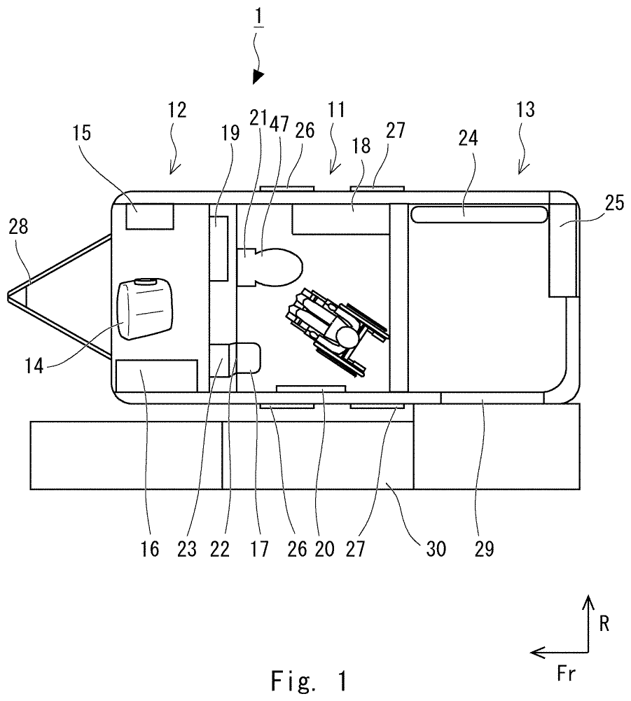

Embodiments according to the present disclosure will be described hereinafter with reference to the drawings. FIG. 1 is a plan view of a vehicle with a toilet according to a first embodiment. A vehicle 1 with a toilet according to the first embodiment includes at least a toilet room 11 inside thereof. The vehicle 1 with the toilet includes, for example, the toilet room 11, a facility room 12 disposed adjacent to and in front of the toilet room 11, and a front room 13 disposed adjacent to and behind the toilet room 11.

In the facility room 12, a toilet tank 14, a water-supply pump 15, a facility illuminator that illuminates the inside of the facility room 12, a facility ventilation fan that ventilates the inside of the facility room 12, an outlet for outside use, a first storage battery 16, and the like are provided. The water-supply pump 15 is disposed in the front-right part of the facility room 12. The water-supply pump 15 supplies water to a shower toilet (Registered Trademark) 47, an ostomate-sink 17 for an ostomate, a washbasin 18, and the like in the toilet room 11. The water-supply pump 15 is driven by a motor or the like, and supplies water.

The toilet tank 14 is disposed adjacent to the water-supply pump 15 and in front of the facility room 12. The outlet for outside use is disposed on the outer side of the facility room 12 and supplies electric power to an external apparatus(es). The first storage battery 16 is disposed on the side surface on the left side of the facility room 12. The first storage battery 16 is formed as a secondary battery capable of being charged and discharged, such as a lithium battery and a nickel-hydrogen battery.

In the toilet room 11, the shower toilet 47, the ostomate-sink 17 for an ostomate, the washbasin 18, an open/close-type ventilation opening and a toilet ventilation fan for ventilating the toilet room 11, a toilet illuminator that illuminates the toilet room 11, an air compressor 19 that performs air conditioning for the inside of the toilet room 11, a monitor 20, and the like are provided.

The shower toilet 47 is disposed in the front-right part of the toilet room 11. The shower toilet 47 is provided with a toilet drain pump 21 that drains water from the toilet seat. The toilet drain pump 21 is driven by a motor or the like, and drains water.

The sink 17 is disposed in the front-left part of the toilet room 11. The sink 17 is provided with an ostomate-sink drain pump 22 that drains water from the ostomate-sink 17 and an electric water heater 23. The ostomate-sink drain pump 22 is driven by a motor or the like, and drains water.

The washbasin 18 is disposed on the side surface on the rear-right part of the toilet room 11. The washbasin 18 is provided with an automatic faucet and an electric water heater. The open/close-type ventilation opening has an opening/closing mechanism that opens and closes the ventilation opening by using a motor or the like. The monitor 20 is provided with a playback apparatus that plays back moving images or the like.

In the front room 13, storage-type bed (i.e., folding-type bed) 24, a front-room illuminator that illuminates the front room 13, an outlet for outside use, a front-room outlet, a mirror illuminator, a second storage battery 25, and the like are provided. The outlet for outside use is disposed on the outer side of the front room 13. The front-room outlet is disposed on the inner side of the front room 13. The mirror illuminator is disposed in a mirror disposed on the side surface on the rear part of the front room 13, and illuminates the mirror.

The storage-type bed 24 is disposed on the side surface on the right side of the front room 13. In a stored state (i.e., in a folded state), the storage-type bed 24 is vertically positioned parallel to the side surface on the right side of the front room 13. Further, in a used state, the storage-type bed 24 is pulled down so that it becomes parallel to the floor surface of the front room 13. The second storage battery 25 is disposed on the side surface on the rear-right part of the front room 13. The second storage battery 25 is formed as a secondary battery capable of being charged and discharged, such as a lithium battery and a nickel-hydrogen battery.

A pair of left and right front wheels 26 and a pair of left and right rear wheels 27 are provided side by side in the longitudinal direction near the center of the lower part of the vehicle 1 with the toilet. The vehicle 1 with the toilet is formed as a towed vehicle. A towed part 28 formed by a roughly V-shaped frame is provided in the front end of the vehicle 1 with the toilet. A towed part 28 of another vehicle equipped with a driving unit such as an engine or a motor is connected to the towed part 28 of the vehicle 1 with the toilet. In this way, the vehicle 1 with the toilet can be towed and moved by the other vehicle. Note that the vehicle 1 with the toilet may be formed as a self-propelled vehicle equipped with a driving unit.

A doorway 29 through which a user enters the front room 13 of the vehicle or exit from the front room 13 is provided on the side surface on the left side of the rear part of the front room 13. The front room 13 and the toilet room 11 are partitioned by a sliding door or the like. The user enters the front room 13 from the doorway 29, enters the toilet room 11 from the front room 13, and uses the toilet.

The doorway 29 of the vehicle is configured so that a slope (i.e., a ramp) 30 can be attached thereto in a detachable manner. The slope 30 extends in the longitudinal direction of the vehicle on the side of the vehicle. Therefore, it is possible to secure at least a certain length of the slope 30 and thereby reduce the inclination angle of the slope 30. Further, it requires only a space equivalent to the width of the slope on the side of the vehicle, and hence does not require a large space.

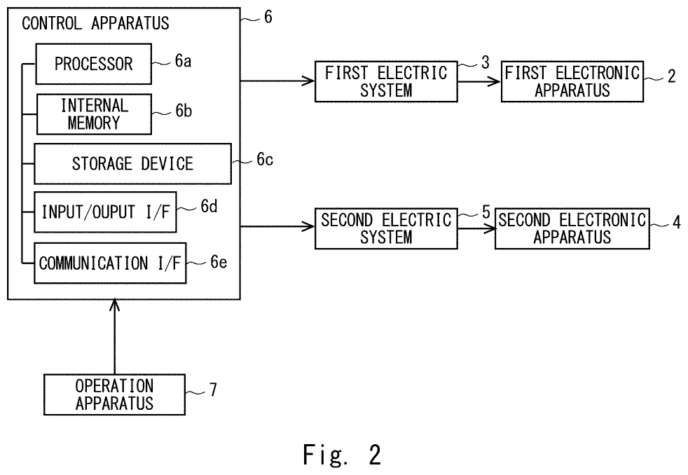

FIG. 2 is a block diagram showing a schematic system configuration of a vehicle with a toilet according to the first embodiment. The vehicle 1 with the toilet includes a first electric system 3 that supplies electric power to a first electronic apparatus 2, a second electric system 5 that supplies electric power to a second electronic apparatus 4, a control apparatus 6 that controls the first and second electric systems 3 and 5, and an operation apparatus 7 through which a user operates the control apparatus 6.

The first electric system 3 is connected to the first electronic apparatus 2 and supplies electric power to the first electronic apparatus 2. The second electric system 5 is connected to the second electronic apparatus 4 and supplies electric power to the second electronic apparatus 4.

The control apparatus 6 has a hardware configuration of an ordinary computer including, for example, a processor 6a such as a CPU (Central Processing Unit) or a GPU (Graphics Processing Unit), an internal memory 6b such as a RAM (random access memory) or a ROM (Read Only Memory), a storage device 6c such as an HDD (Hard Disk Drive) or an SDD (Solid State Drive), an input/output I/F (Interface) 6d for connecting a peripheral apparatus(es) such as a display to the computer, and a communication I/F 6e for communicating with an external apparatus(es).

The control apparatus 6 can implement each of the below-described functions, for example, by having the processor 6a execute a program(s) stored in the storage device 6c, the internal memory 6b, or the like while using the internal memory 6b.

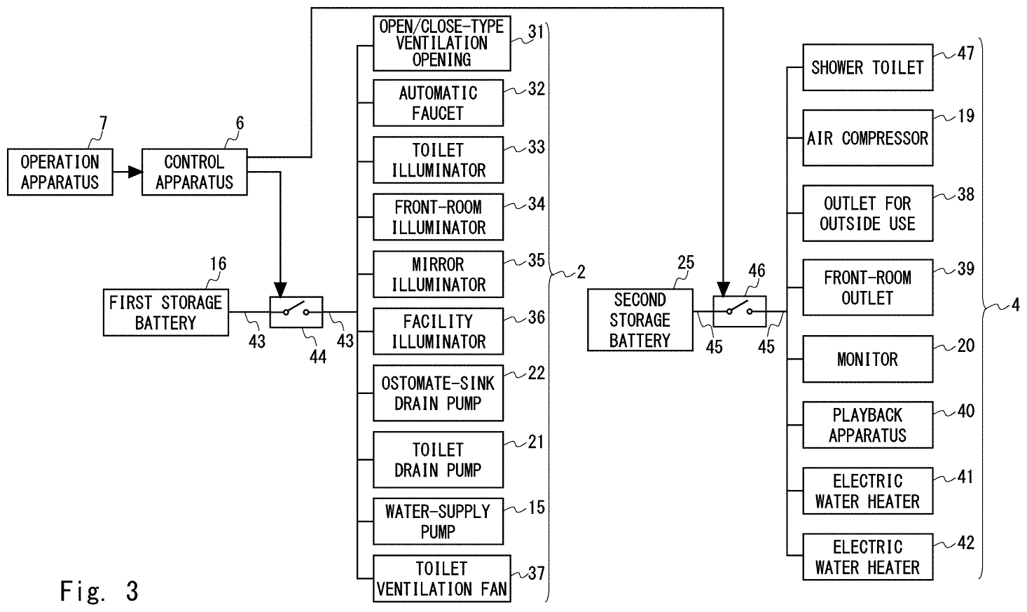

FIG. 3 is a detailed diagram of the first and second electric systems and the first and second electronic apparatuses. The first electric system 3 includes a first storage battery 16, a wiring line(s) 43, a switch(es) 44, and the like. The first storage battery 16 is connected to the first electronic apparatus 2 through the wiring line 43. The first storage battery 16 supplies electric power to the first electronic apparatus 2 through the wiring line 43.

The wiring line 43 is provided with the switch 44. The switch 44 is formed, for example, as a mechanical or electronic switch that switches its state between an On-state and an Off-state according to a control signal sent from the control apparatus 6. When the switch 44 is turned on, the wiring line 43 is brought into a connected state, whereas when it is turned off, the wiring line 43 is switched to a non-connected state. In this way, the first storage battery 16 is switched to a state in which it supplies electric power to the first electronic apparatus 2 and a state in which it does not supply electric power to the first electronic apparatus 2.

The first electronic apparatus 2 is, among a plurality of electronic apparatuses installed in the vehicle 1 with the toilet, an electronic apparatus that is essential for operating the toilet room 11. The first electronic apparatus 2 includes at least an ostomate-sink drain pump 22, a toilet drain pump 21, and a water-supply pump 15. As shown in FIG. 3, the first electronic apparatus 2 includes, for example, an open/close-type ventilation opening 31, an automatic faucet 32, a toilet illuminator 33, a front-room illuminator 34, a mirror illuminator 35, a facility illuminator 36, the ostomate-sink drain pump 22, the toilet drain pump 21, the water-supply pump 15, a toilet ventilation fan 37, and the like.

The second electric system 5 includes a second storage battery 25, a wiring line(s) 45, and a switch(es) 46, and the like. The second storage battery 25 supplies electric power to the second electronic apparatus 4 through the wiring line 45. The wiring line 45 is provided with the switch 46. When the switch 46 is turned on, the wiring line 45 is brought into a connected state, whereas when it is turned off, the wiring line 45 is switched to a non-connected state. In this way, the second storage battery 25 is switched to a state in which it supplies electric power to the second electronic apparatus 4 and a state in which it does not supply electric power to the second electronic apparatus 4.

Note that the first storage battery 16 of the first electric system 3 and the second storage battery 25 of the second electric system 5 may be connected to each other by a wiring line or the like. In such a case, the first storage battery 16 may charge the second storage battery 25, or the second storage battery 25 may charge the first storage battery 16.

The second electronic apparatus 4 is, among the plurality of electronic apparatuses installed in the vehicle 1 with the toilet, an electronic apparatus that is not essential for operating the toilet room 11, i.e., an electronic apparatus other than the first electronic apparatus 2. The second electronic apparatus 4 includes, for example, a shower toilet 47, an air compressor 19, an outlet for outside use 38, a front-room outlet 39, a monitor 20, a playback apparatus 40, an electric water heater 41 for the washbasin 18, an electric water heater 42 for the ostomate-sink 17, and the like.

The control apparatus 6 is a specific example of the control means. The control apparatus 6 controls switching between the On/Off states of the switches 44 and 46 of the first and second electric systems 3 and 5 by transmitting a control signal(s) to the switches 44 and 46 according to an operation signal sent from the operation apparatus 7.

The operation apparatus 7 is composed of, for example, an operation switch(es) and/or an operation panel provided in the vehicle 1 with the toilet. A user can provide (i.e., enter) an operational instruction to the control apparatus 6 by operating the operation apparatus 7. The operation apparatus 7 may be a portable terminal such as a smartphone possessed by the user. In this way, it is possible to remotely control the control apparatus 6. The operation apparatus 7 transmits a first operation signal for instructing the control apparatus 6 to enter a first state (which will be described later) and a second operation signal for instructing it to enter a second state according to the operation performed by the user.

The control apparatus 6 is a specific example of the control means. The control apparatus 6 controls switching between the On/Off states of the switches 44 and 46 of the first and second electric systems 3 and 5.

It should be noted that, for example, when each of various electronic apparatuses installed in the vehicle is operated, a large amount of electric power is consumed, so that there is a risk that sufficient electric power for operating the toilet installed in the vehicle may not be secured. Therefore, there is a demand for saving electric power in the vehicle.

To that end, in the first embodiment, the control apparatus 6 performs control so as to perform switching between a first state in which the control apparatus 6 controls the first electric system 3 and supplies electric power only to the first electronic apparatus and a second state in which the control apparatus 6 controls the first and second electric systems 3 and 5 and supplies electric power to the first and second electronic apparatuses 2 and 4.

In this way, by switching the state to the first state in which electric power is supplied only to the first electronic apparatus 2 that is essential for operating the toilet room 11, it is possible to save electric power in the vehicle and thereby secure sufficient electric power for operating the toilet. On the other hand, by switching the state to the second state in which electric power is supplied to the first and second electronic apparatuses 2 and 4, all the electronic apparatuses in the vehicle 1 with the toilet can be used as usual and hence the usability for the user is ensured.

For example, under normal circumstances, the control apparatus 6 transmits a control signal(s) to the switches 44 and 46 of the first and second electric systems 3 and 5 according to a second operation signal transmitted from the operation apparatus 7, and thereby performs control to switch the state to the second state in which electric power is supplied from the first storage battery 16 to the first electronic apparatus 2 and electric power is also supplied from the second storage battery 25 to the second electronic apparatus 4. In the second state, since electric power is supplied to all the electronic apparatuses in the vehicle 1 with the toilet, the user can use all the electronic apparatuses of the vehicle 1 with the toilet as usual.

On the other hand, in the event of a disaster or the like, the control apparatus 6 transmits a control signal to the switch 44 of the first electric system 3 according to a first operation signal transmitted from the operation apparatus 7, and thereby performs control to switch the state to the first state in which electric power is supplied from the first storage battery 16 only to the first electronic apparatus 2. In the first state, since electric power is supplied only to the first electronic apparatus 2, which is essential for operating the toilet, it is possible to secure sufficient electric power for operating the toilet, which is essential equipment especially in the disaster or the like.

### Second Embodiment

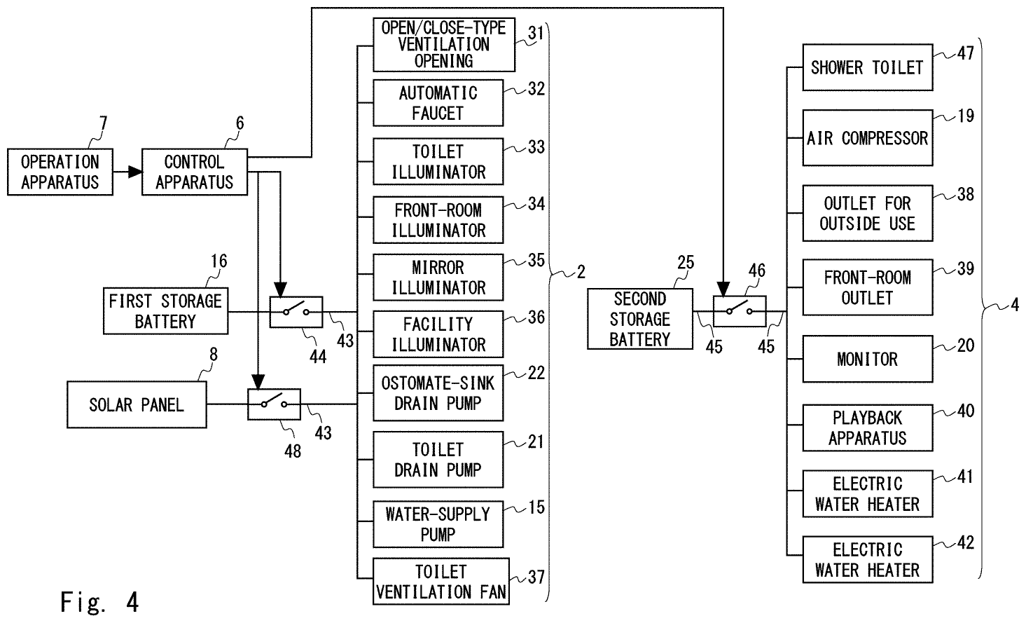

FIG. 4 is a block diagram showing a system configuration of a vehicle with a toilet according to a second embodiment. In the second embodiment, the first electric system 3 further includes a solar panel 8 in addition to the above-described components/structures. It is possible to operate the toilet for a longer time by using electric power generated by the solar panel 8.

The solar panel 8 is connected to the first electronic apparatus 2 and the first storage battery 16 through a wiring line(s). The solar panel 8 is a solar-cell module which is an aggregation of solar cells each of which receives sunlight and generates electric power.

The solar panel 8 is disposed on, for example, the ceiling of the vehicle 1 with the toilet. The solar panel 8 outputs electric power generated by sunlight to the first storage battery 16 through a wiring line and thereby charges the first storage battery 16. The solar panel 8 may also output electric power generated by sunlight to the first electronic apparatus 2 through a wiring line.

The vehicle 1 with the toilet may be provided with other renewable energy-type generators in place of or in addition to the solar panel 8. Examples of the other renewable energy-type electric generator include an aerogenerator, a hydroelectric generator, a biomass generator, and the like.

The wiring line 43 is provided with a switch 48. The state of the switch 48 is switched between an On-state and an Off-state according to a control signal sent from the control apparatus 6. When the switch 48 is turned on, the wiring line 43 is brought into a connected state, whereas when it is turned off, the wiring line 43 is switched to a non-connected state. In this way, the state of the solar panel 8 is switched to a state in which it supplies electric power to the first electronic apparatus 2 and a state in which it does not supply electric power to the first electronic apparatus 2.

For example, the control apparatus 6 transmits a control signal to the switch 48 of the first electric system 3 according to the first operation signal transmitted from the operation apparatus 7, and thereby performs control to switch the state to the first state in which electric power is supplied from the solar panel 8 only to the first electronic apparatus 2. Note that the control apparatus 6 may transmit a control signal(s) to the switches 44 and 48 of the first electric system 3, and thereby perform control to switch the state to the first state in which electric power is supplied from both the first storage battery 16 and the solar panel 8 only to the first electronic apparatus 2.

When the control apparatus 6 determines that the amount of electricity stored in the first storage battery 16 is equal to or smaller than a predetermined amount, or the first storage battery 16 has failed, it may automatically perform control to switch the state to the first state in which electric power is supplied from the solar panel 8 only to the first electronic apparatus 2.

The control apparatus 6 may determine that the first storage battery 16 has failed when the amount of electricity stored in the first storage battery 16 is equal to or smaller than a predetermined amount even after a certain charging time has elapsed, or when the amount of electricity stored in the first storage battery 16 is out of a proper range.

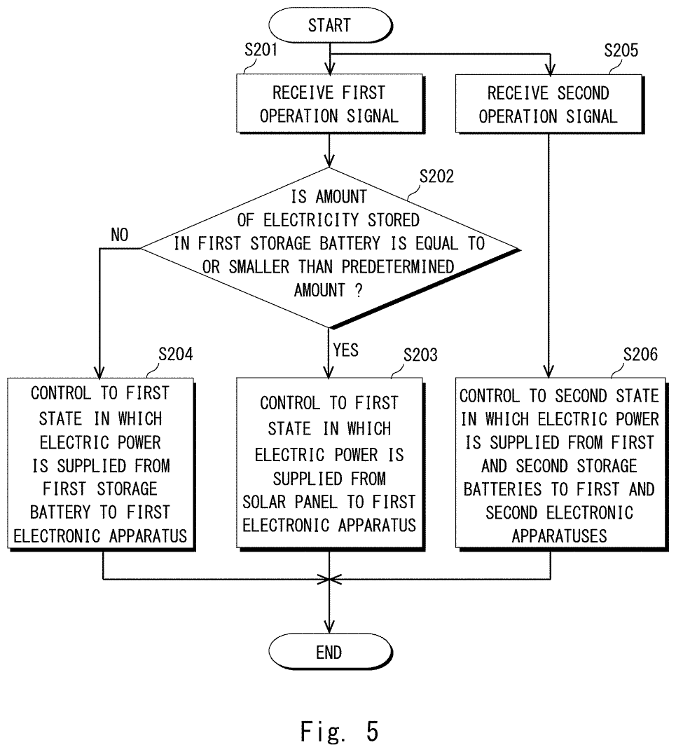

Next, an example of a control process performed by the above-described control apparatus 6 will be described. FIG. 5 is a flowchart showing a process flow for controlling the vehicle with the toilet according to the second embodiment.

When the control apparatus 6 receives a first operation signal (step S201), it determines whether or not the amount of electricity stored in the first storage battery 16 is equal to or smaller than a predetermined amount (step S202).

When the control apparatus 6 determines that the amount of electricity stored in the first storage battery 16 is equal to or smaller than the predetermined amount (YES in step S202), it transmits a control signal to the switch 48 of the first electric system 3 and thereby performs control to switch the state to the first state in which electric power is supplied from the solar panel 8 only to the first electronic apparatus 2 (step S203).

On the other hand, when the control apparatus 6 determines that the amount of electricity stored in the first storage battery 16 is larger than the predetermined amount (NO in step S202), it transmits a control signal to the switch 44 of the first electric system 3 and thereby performs control to switch the state to the first state in which electric power is supplied from the first storage battery 16 only to the first electronic apparatus 2 (step S204).

When the control apparatus 6 receives a second operation signal (step S205), it transmits a control signal(s) to the switches 44 and 46 of the first and second electric systems 3 and 5, and thereby performs control to switch the state to the second state in which electric power is supplied from the first storage battery 16 to the first electronic apparatus 2 and electric power is also supplied from the second storage battery 25 to the second electronic apparatus 4 (step S206).

Several embodiments according to the present disclosure have been explained above. However, these embodiments are shown as examples but are not shown to limit the scope of the disclosure. These novel embodiments can be implemented in various forms. Further, their components/structures may be omitted, replaced, or modified without departing from the scope and spirit of the disclosure. These embodiments and their modifications are included in the scope and the spirit of the disclosure, and included in the scope equivalent to the invention specified in the claims.

For example, although first and second electric systems 3 and 5 are formed as separate systems in the above-described embodiments, the configuration of them is not limited to this example. The first and second electric systems 3 and 5 may be integrally formed with each other.

Although electric power is supplied from the first and second storage batteries 16 and 25 to the first and second electronic apparatuses 2 and 4 in the above-described embodiments, the configuration of them is not limited to this example. Electric power may be supplied to the first and second electronic apparatuses 2 and 4 from a power supply(ies) disposed outside the vehicle 1 with the toilet.

In the present disclosure, it is also possible to implement the processes shown in FIG. 4, for example, by having the processor 6a execute a computer program(s).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Compact Disc-Read Only Memory), CD-R (Compact Disc-Recordable), CD-R/W (Compact Disc Rewritable), and semiconductor memories (such as mask ROM, PROM (Programmable ROM), EPROM (Erasable PROM), flash ROM, RAM (Random Access Memory), etc.).

The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The control apparatus 6 according to the above-described embodiments can be implemented not only by a program, but also by dedicated hardware such as an ASIC (Application Specific Integrated Circuit) or an FPGA (Field-Programmable Gate Array).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A vehicle with a toilet comprising a toilet room, the vehicle with the toilet further comprising:
a first electronic apparatus installed in the vehicle, the first electronic apparatus being configured to operate the toilet room;
a first electric system connected to the first electronic apparatus, the first electric system being configured to supply electric power to the first electronic apparatus;
a second electronic apparatus different from the first electronic apparatus installed in the vehicle;
a second electric system connected to the second electronic apparatus, the second electric system being configured to supply electric power to the second electronic apparatus; and
control means for performing control for switching between a first state and a second state, the first state being a state in which the control means controls the first electric system and supplies electric power only to the first electronic apparatus, and the second state being a state in which the control means controls the first and second electric systems and supplies electric power to the first and second electronic apparatuses.

2. The vehicle with the toilet according to claim 1, wherein the first and second electric systems comprise a storage battery configured to supply electric power to the first and second electronic apparatuses.

3. The vehicle with the toilet according to claim 2, wherein the first electric system comprises a renewable energy-type electric generator configured to generate renewable energy and supply the generated renewable energy to the first electronic apparatus.

4. The vehicle with the toilet according to claim 3, wherein when the control means determines that an amount of electricity stored in the storage battery is equal to or smaller than a predetermined amount, or the storage battery has failed, the control means controls the first electric system and switches its state to a first state in which electric power is supplied from the renewable energy-type electric generator to the first electronic apparatus.

5. The vehicle with the toilet according to claim 1, wherein the first electronic apparatus comprises at least an ostomate-sink drain pump through which water is drained from an ostomate-sink for an ostomate, a toilet drain pump through which water is drained from the toilet, and a water-supply pump through which water is supplied to the toilet.

6. A method for controlling a vehicle with a toilet, the vehicle with the toilet further comprising:
a first electronic apparatus installed in the vehicle, the first electronic apparatus being configured to operate a toilet room;
a first electric system connected to the first electronic apparatus, the first electric system being configured to supply electric power to the first electronic apparatus;
a second electronic apparatus different from the first electronic apparatus installed in the vehicle; and
a second electric system connected to the second electronic apparatus, the second electric system being configured to supply electric power to the second electronic apparatus, wherein
the method comprises performing control for switching between a first state and a second state, the first state being a state in which the control means controls the first electric system and supplies electric power only to the first electronic apparatus, and the second state being a state in which the control means controls the first and second electric systems and supplies electric power to the first and second electronic apparatuses.
